(19) United States
(12) Patent Application Publication
(10) Pub. No.: US 2019/0024218 A1
(43) Pub. Date: Jan. 24, 2019

(54) ALUMINUM ALLOY FOIL AND MANUFACTURING METHOD THEREOF

(71) Applicant: UACJ Corporation, Tokyo (JP)

(72) Inventors: Yuichi TANAKA, Aichi (JP); Tetsuya MOTOI, Aichi (JP)

(73) Assignee: UACJ Corporation, Tokyo (JP)

(21) Appl. No.: 16/073,162

(22) PCT Filed: Jan. 24, 2017
(86) PCT No.: PCT/JP2017/002383

§ 371 Date: Jul. 26, 2018

(30) Foreign Application Priority Data
Feb. 1, 2016 (JP) 2016-017253

(51) Int. Cl. C22C 21/00; C22F 1/04; H01M 4/66

(52) U.S. Cl. CPC C22C 21/00; H01G 11/68; H01M 4/662; C22F 1/04

(57) ABSTRACT

A high-strength, highly-elongatable aluminum-alloy foil contains, in mass %, Fe: 1.0% or more and 2.0% or less and Mn: 0.05% or less, and unavoidable impurities. The aluminum-alloy foil has an average crystal-grain size at a foil surface of 2.5 μm or less, and a ratio of the surface-area percentages of the crystal orientations A_{{112}<111>}/A_{{101}<121>} is 3.0 or more. A_{{112}<111>} is the percentage, with respect to the total surface area, of the surface areas of crystal grains in which the crystal orientation is in a range within 15° from {112}<111> in an orientation-mapping image of the foil surface produced by electron backscatter diffraction. A_{{101}<121>} is the percentage, with respect to the total surface area, of the surface areas of the crystal grains in which the crystal orientation is in a range within 15° from {101}<121> in the orientation-mapping image.

### TECHNICAL FIELD

The present invention relates to an aluminum-alloy foil and to a manufacturing method thereof.

### BACKGROUND ART

Aluminum-alloy foils have been used as current collectorssuch as of secondary batteries, electric double-layer capacitors, and lithium-ion capacitorsand the like. For example, in a lithium-ion secondary battery, the positive electrode is normally manufactured by applying a mixture slurry, which contains an electrode active material, onto a surface of an aluminum-alloy foil, which serves as a current collector, drying it, and applying compression using a press. Typically, the manufactured positive electrode is placed in a state of being stacked with a separator and a negative electrode or in a state in which they are rolled up as is in the stacked state, and housed in a case.

In the electrode manufacturing process above, during the drying after coating with the mixture slurry, it is heat treated at approximately 100° C.-160° C. In addition, for example, a technique is disclosed in Patent Document 1 that heat treats an electrode, which contains an aluminum-alloy foil, for several hours at a temperature of 50° C.-350° C. and is accompanied by thermal degeneration of binders, thickeners, etc., which were added to the mixture slurry. Thus, there are situations in which the aluminum-alloy foil is exposed to a high temperature state for a long time in the electrode manufacturing process.

An aluminum-alloy foil for a lithium battery comprising Mn: 1.0-1.5 mass % and Cu: 0.05-0.20 mass %, the remainder being Al and impurities, is disclosed, e.g., in Patent Document 2 as an aluminum-alloy foil used in this type of electrode.

In addition, an aluminum-alloy foil comprising Mn: 0.10-1.50 mass % and Fe: 0.20-1.50 wt. %, wherein the total of Mn and Fe is 1.30-2.10 wt. %, the remainder being Al and unavoidable impurities, is disclosed in Patent Document 3.

### PRIOR ART LITERATURE

### Patent Documents

Patent Document 1

Japanese Laid-open Patent Publication 2008-277196
Patent Document 2

Japanese Laid-open Patent Publication H11-67220
Patent Document 3

Japanese Patent No. 5567719

### SUMMARY OF THE INVENTION

### Problem(s) to be Solved by the Invention

However, previously-known techniques have a problem with respect to the following point. That is, aluminum-alloy foils used in the current collector of a positive electrode or the like in a lithium-ion secondary battery require high strength to prevent the occurrence of tearing during the coating of the mixture slurry, the occurrence of breaks at bent parts arising during rolling up, etc.

However, the heat treatment during the electrode manufacturing process described above decreases the strength of the aluminum-alloy foil. If the strength of the aluminum-alloy foil decreases, because central buckling tends to occur during press working, curling during rolling up, a decrease of the adhesion between the active material and the aluminum-alloy foil, breaks during formation of slits in a subsequent process, etc., tend to occur.

But, it does not necessarily mean that it is good if the aluminum alloy does not soften when subjected to heat treatment. This is because breaks of the aluminum-alloy foil still tend to occur even when elongation caused by the heat treatment is decreased. In addition, in a lithium-ion secondary battery, expansion and contraction of the active material occurs during charging and discharging. Consequently, stress is applied to the aluminum-alloy foil that serves as a current collector even after having been assembled as a battery. Therefore, when the elongation of the aluminum-alloy foil is low, breaks tend to occur because the aluminum-alloy foil cannot conform to the deformations of the active material caused by the expansion and contraction.

It is noted that, in Patent Documents 2, 3 described above, although there is a reference concerning the strength after heat treatment, there is no description concerning the elongation after heat treatment.

The present invention has been made in view of the above-mentioned background, and it is intended to provide an aluminum-alloy foil that has high strength and large elongation, even after being subjected to a heat treatment during an electrode manufacturing process or the like.

### Means for Solving the Problems

One aspect of the present invention is an aluminum-alloy foil, wherein:

the chemical composition contains, in mass %, Fe: 1.0% or more and 2.0% or less and Mn: 0.05% or less, the remainder being Al and unavoidable impurities; and

an average crystal-grain size at a foil surface is 2.5 μm or less, and a ratio of the surface-area percentages of the crystal orientations A_{{112}<111>}/A_{{101}<121>} is 3.0 or more.

Therein, the above-mentioned A_{{112}<111>} is the percentage, with respect to the total surface area, of the surface areas of crystal grains in which the crystal orientation is in a range within 15° from {112}<111>in an orientation-mapping image of the foil surface produced by electron backscatter diffraction, and the above-mentioned A_{{101}<121>} is the percentage, with respect to the total surface area, of the surface areas of the crystal grains in which the crystal orientation is in a range within 15° from {101}<121> in the orientation-mapping image.

Another aspect of the present invention is an aluminum-alloy-foil manufacturing method in which an aluminum-alloy ingot is made into a foil shape by hot rolling and then cold rolling, wherein:

in the aluminum-alloy ingot, the chemical composition contains, in mass %, Fe: 1.0% or more and 2.0% or less and Mn: 0.05% or less, the remainder being Al and unavoidable impurities;

a homogenization treatment is not performed before the hot rolling;

the temperature during the hot rolling is 350° C. or less; and

the cold rolling is performed without a midstream annealing being performed, and a foil thickness is set to 20 μm or less.

### Effects of the Invention

The aluminum-alloy foil has the above-specified chemical composition, wherein the average crystal-grain size at the foil surface and the ratio of the surface-area percentages of the crystal orientations are in the above-specified range. Consequently, the aluminum-alloy foil has high strength and large elongation even after being subjected to a heat treatment during an electrode manufacturing process or the like. Therefore, according to the above-described aluminum-alloy foil, the electrode tends not to break during manufacturing processes after the heat treatment, when battery charging and discharging is performed repeatedly, or the like.

### MODES FOR CARRYING OUT THE INVENTION

The above-mentioned aluminum-alloy foil and the manufacturing method thereof will now be explained.

The significance of and the reasons for limits in the chemical composition (the unit is mass % but is abbreviated simply as “%” in the explanation of the chemical composition below) of the aluminum-alloy foil are as below.

Fe: 1.0% or more and 2.0% or less

Fe functions to increase the strength of the aluminum-alloy foil and to decrease the softening temperature of the aluminum-alloy foil. These functions can be obtained by controlling both the solid solution amount of Fe and the precipitation state of Fe so as to increase the strength of the aluminum-alloy foil and decrease the recrystallization temperature.

Fe that is present in a solid solution in the aluminum-alloy foil inhibits the migration of dislocations and prevents the strength of the aluminum-alloy foil from decreasing excessively. On the other hand, by dispersing numerous compounds, which are precipitated as Al—Fe-based compounds, as Al—Fe-based fine compounds that are not matched with the Al matrix, restoration of the worked structure is promoted during heat treatment. Consequently, even if the recrystallization temperature of the aluminum-alloy foil is decreased and the heat treatment is performed at 350° C. or less, a large elongation can be obtained.

If the Fe content becomes less than 1.0%, the dispersion of the Al—Fe-based fine compounds, which are not matched with the Al matrix (matrix), becomes insufficient, and the decrease in the recrystallization temperature of the aluminum-alloy foil becomes difficult. On the other hand, if the Fe content exceeds 2.0%, then coarse Al—Fe-based compounds that exceed several hundred micrometers are formed during casting, which leads to the occurrence of pinholes (perforations) during foil rolling, whereby the manufacture of a robust foil material becomes difficult. From the above-mentioned viewpoint, the Fe content can be set preferably to 1.1% or more and more preferably to 1.2% or more. In addition, the Fe content can be set preferably to 1.9% or less, more preferably to 1.8% or less, and yet more preferably to 1.7% or less.

Mn: 0.05% or Less

If the Mn content exceeds 0.05%, then elongation after the heat treatment decreases. Consequently, if used as a current collector, it becomes difficult to conform to changes of the active material caused by the expansion and contraction during charging and discharging, and breaks tend to occur. Therefore, the Mn content is set to 0.05% or less. The Mn content is preferably 0.03% or less and more preferably 0.01% or less. It is noted that Mn is often contained in commonly used Al metals as an impurity. Consequently, to restrict the Mn content to less than 0.001%, it is necessary to use a high-purity base metal. Accordingly, from the viewpoint of cost savings, etc., the Mn content can be set preferably to 0.001% or more.

The above-mentioned chemical composition can further contain at least one of Si and Cu within the content ranges described below.

Si: 0.01 or More and 0.6% or Less

Si is an element that contributes to increasing the strength of aluminum-alloy foil. The Si content can be set to 0.01% or more from the viewpoint of obtaining the strength-increasing effect of the additive. It is noted that Si is often contained in commonly used Al metals as an impurity. Consequently, less than 0.01% of Si may be contained as an unavoidable impurity. Of course, to restrict the Si content to less than 0.01%, it is necessary to use a high-purity base metal. Accordingly, from the viewpoint of cost savings, the Si content can be set to 0.01% or more. On the other hand, if the Si content is 0.6% or less, then it becomes easier to achieve a further increase in the strength of the aluminum-alloy foil and, moreover, it becomes difficult for coarse Si single-phase particles to be formed, and therefore problems such as pinholes and foil tearing tend not to occur at a foil thickness of 20 μm or less. From this viewpoint, the Si content can be set preferably to 0.05% or more, and more preferably, to 0.1% or more. In addition, the Si content can be set preferably to 0.5% or less, and more preferably, to 0.4% or less.

Cu: 0.001% or More and 0.1% or Less

Cu is an element that contributes to increasing the strength of aluminum-alloy foil. The Cu content can be set to 0.001% or more from the viewpoint of obtaining the strength-increasing effect of the additive. It is noted that 0.001% or less of Cu may be contained as an unavoidable impurity. Furthermore, to restrict the Cu content to less than 0.001%, it is necessary to use a high-purity base metal. Accordingly, from the viewpoint of cost savings as well, the Cu content can be set to 0.001% or more. On the other hand, if the Cu content is 0.1% or less, then elongation after heat treatment of the aluminum-alloy foil tends not to decrease. From this viewpoint, the Cu content can be set preferably to 0.002% or more and more preferably to 0.005% or more. In addition, the Cu content can be set preferably to 0.09% or less and more preferably to 0.08% or less.

The above-mentioned chemical composition may include elements such as Cr, Ni, Zn, Mg, B, V, and Zr as unavoidable impurities. It is noted that there is a risk that these elements will reduce elongation after heat treatment of the aluminum-alloy foil. Consequently, each of these elements is preferably restricted to 0.02% or less and the total amount of these elements is preferably restricted to 0.07% or less.

The average crystal-grain size at the foil surface of the aluminum-alloy foil is 2.5 μm or less. It is noted that the foil surface is the foil surface that is perpendicular to the thickness direction of the foil. If the average crystal-grain size at the foil surface is more than 2.5 μm, then some of the crystal grains grow conspicuously large during heat treatment, and thereby the strength of the aluminum-alloy foil decreases. From the viewpoint of increasing the strength and the like of the aluminum-alloy foil, the average crystal-grain size at the foil surface can be set preferably to 2.4 μm or less, more preferably to 2.3 μm or less, and yet more preferably to 2.2 μm or less. It is noted that because the finer the crystal grain the better, the lower limit of the average crystal-grain size at the foil surface is not particularly limited.

A method of measuring the average crystal-grain size is as follows. The foil surface of the aluminum-alloy foil, which serves as the measurement sample, is smoothened by electrolytic polishing. Then, that smoothened foil surface is analyzed by electron backscatter diffraction (EBSD) using an SEM with the observation magnification set to 500 times, and thereby an orientation-mapping image is obtained. Measurements are performed at five visual fields for each sample. Furthermore, based on the resulting orientation-mapping image, a boundary in which the orientation difference is 15° or more is taken as the crystal-grain boundary, the region enclosed by the boundary is taken as one crystal grain, and a circle-equivalent diameter is calculated from the surface area of the one crystal grain and taken as the crystal-grain size. The average of the crystal-grain sizes is calculated as a surface-area-weighted average, and the average of the five visual fields is taken as the final average crystal-grain size.

In the aluminum-alloy foil, the ratio of the surface-area percentages of the crystal-orientations A_{{112}<111>}/A_{{101}<121>} at the foil surface is 3.0 or more.

The ratio of the surface-area percentages of the crystal orientations at the foil surface is derived utilizing the orientation-mapping image of the foil surface described above. A_{{112}<111>} is the percentage, with respect to the total surface area, of the surface areas of the crystal grains in which the crystal orientation is in a range within 15° from {112}<111> in the orientation-mapping image. A_{{101}<121>} is the percentage, with respect to the total surface area, of the surface areas of the crystal grains in which the crystal orientation is in a range within 15° from {101}<121> in the orientation-mapping image.

A_{{112}<111>}/A_{{101}<121>} varies according to the degree with which the aluminum-alloy foil is worked. If A_{{112}<111>}/A_{{101}<121>} falls below 3.0, then the accumulation of work-hardening-dependent strain becomes insufficient and an increase in the fineness of the crystal grains after heat treatment is not sufficiently produced, and thereby the strength of the aluminum-alloy foil decreases. In the case of common aluminum-alloy-foil manufacturing methods, such as one in which midstream annealing is performed, the accumulation of strain attendant with the working is greatly affected only by the cold rolling conditions after the midstream annealing. However, if hot rolling is performed at a comparatively low temperature and the aluminum-alloy foil is manufactured without midstream annealing being performed, then the accumulation of strain not only during cold rolling but also during hot rolling at low temperature becomes an important factor. From the viewpoint of increasing the strength of the aluminum-alloy foil, A_{{112}<111>}/A_{{101}<121>} can be set preferably to 3.5 or more, more preferably to 4.0 or more, and yet more preferably to 4.5 or more.

When the aluminum-alloy foil is used, for example, as a current collector, the foil thickness should be 20 μm or less from the viewpoint of further increasing the ratio of the active material to the volume of the entire battery with the aim of increasing battery capacity. The foil thickness can be set preferably to 18 μm or less and more preferably to 15 μm or less. It is noted that the lower limit of the foil thickness is not particularly limited; however, from the viewpoint of making it suitable for use as a current collector, the foil thickness can be set to 8 μm or more.

From the viewpoint of reliably ensuring a breakage-prevention effect, the tensile strength of the aluminum-alloy foil may be 120 MPa or more. It is noted that the tensile strength is a value that is measured in accordance with JIS Z2241.

From the viewpoint of reliably ensuring the breakage-prevention effect, the elongation of the aluminum-alloy foil may be 6% or more. It is noted that elongation is a value that is measured in accordance with JIS Z2241.

The aluminum-alloy foil can be suitably used as a current collector in, for example: a secondary battery, such as a lithium-ion secondary battery; an electric double-layer capacitor; a lithium-ion capacitor; and the like. More specifically, for example, if the aluminum-alloy foil will be used as the current collector of a lithium-ion secondary battery, then a mixture that principally contains an electrode active material is applied onto the surface of the aluminum-alloy foil serving as the current collector. Specifically, a mixture slurry that contains the electrode active material is applied onto the surface of the aluminum-alloy foil and dried, after which a press process is performed with the aims of compacting the mixture layer and increasing adhesion to the current collector. In addition to the above-mentioned processes, a heat treatment, which is accompanied by thermal degeneration of binders, thickeners, etc., which were added to the mixture slurry, is also performed. Although the electrode that comprises the current collector is held for approximately several hours at 50-350° C. during the drying and heat treatments, the strength and the elongation of the aluminum-alloy foil are high even after these heat treatments, and the electrode tends not to break when used in subsequent processes, when used as a battery, etc.

In the aluminum-alloy-foil manufacturing method, an aluminum-alloy ingot having the above-mentioned chemical composition is hot rolled without performing a homogenization treatment. Here, “without performing a homogenization treatment” means that a heat treatment for homogenization like that conventionally performed at a high temperature of more than 350° C. prior to hot rolling is positively not performed. A phenomenon in which homogenization inevitably occurs in no small measure when the aluminum-alloy ingot is heated to 350° C. or less to perform hot rolling scarcely has any effects on foil strength, elongation, etc., and therefore is permissible. It is noted that if a homogenization treatment is performed, then precipitation of solid solution elements, such as Si and Fe, proceeds, and the amount of solid solutes of these elements decreases. As a result, this leads to a decrease of strength owing to the reduction of the solid solution hardening effect, the coarsening of the crystal grains, etc.

In the aluminum-alloy-foil manufacturing method, hot rolling is performed at a temperature of 350° C. or less. That is, the temperature during hot rolling is set to 350° C. or less at the start and the end of hot rolling, which is when temperature measurement is easy to perform. On the other hand, the lower limit value of the temperature during hot rolling is not particularly limited, but can be set to 150° C. from the viewpoint of preventing an increased load on the rolling mill owing to the increased resistance to deformation.

In addition, the hold time after the hot-rolling start temperature is reached is not particularly limited, but can be set to 12 hours or less from the viewpoint of easily inhibiting the precipitation of Al—Fe—Si-based compounds. It is noted that hot rolling may be performed one time or may be divided up into multiple times, such as by performing a finish rolling after a rough rolling.

The aluminum-alloy-foil manufacturing method obtains an aluminum-alloy foil by performing cold rolling after hot rolling. At this time, annealing is not performed in the course of the cold rolling. The performance of the midstream annealing releases work strain, and miniaturization of the crystal grains is made difficult, which lead to a decrease in strength after heat treatment. In addition, promotion of the precipitation of Al—Fe—Si-based compounds also leads to a decrease in strength after heat treatment. It is noted that a final annealing after the conclusion of the cold rolling is also preferably not performed for the same reasons as the midstream annealing.

The foil thickness after the cold rolling is set to 20 μm or less from the viewpoint that, for example, when the aluminum-alloy foil is used as a current collector, the percentage of the active material to the volume of the entire battery is further increased with the aim of increasing the battery capacity. The foil thickness can be set preferably to 18 μm or less and more preferably to 15 μm or less. It is noted that the lower limit of the foil thickness is not particularly limited and can be set to 8 μm or more from the viewpoint of making it suitable for use as a current collector. It is noted that cold rolling can be performed one time or multiple times. From the viewpoint of promoting an increased fineness of the crystal grains, the total reduction in cold rolling should preferably be 95% or more and more preferably be 98% or more. It is noted that the total reduction in cold rolling is a value that is calculated by 100×(the sheet thickness of the hot-rolled sheet before cold rolling−the foil thickness of the aluminum-alloy foil after the final cold rolling)/(the sheet thickness of the hot-rolled sheet before cold rolling).

It is noted that each of the configurations described above can be arbitrarily combined as needed to obtain the functions and effects described above.

### WORKING EXAMPLES

Aluminum-alloy foils and manufacturing methods thereof according to working examples are explained below.

### Working Example 1

Aluminum-alloy ingots were prepared by manufacturing ingots, by a semicontinuous-casting method, of aluminum alloys having the chemical compositions shown in Table 1 and then surface milling the ingots. It is noted that, of the aluminum alloys having the chemical compositions shown in Table 1, alloys A-F are aluminum alloys having chemical compositions suited to the working examples, and alloys G-K are aluminum alloys having chemical compositions for comparative examples.

TABLE 1

| | Chemical Composition (mass %) | | | | |
|---|---|---|---|---|---|
| Alloy | Fe | Mn | Si | Cu | Al |
| A | 1.4 | 0.008 | 0.05 | 0.002 | bal. |
| B | 1.0 | 0.006 | 0.18 | 0.005 | bal. |
| C | 1.7 | 0.009 | 0.24 | 0.006 | bal. |
| D | 1.5 | 0.042 | 0.34 | 0.025 | bal. |
| E | 1.5 | 0.007 | 0.57 | 0.009 | bal. |
| F | 1.4 | 0.007 | 0.26 | 0.071 | bal. |
| G | 1.5 | 0.009 | 0.69 | 0.006 | bal. |
| H | 0.6 | 0.008 | 0.24 | 0.008 | bal. |
| I | 2.4 | 0.007 | 0.22 | 0.005 | bal. |
| J | 1.4 | 0.006 | 0.23 | 0.141 | bal. |
| K | 1.4 | 0.088 | 0.10 | 0.008 | bal. |

The prepared aluminum-alloy ingots were hot rolled, without undergoing a homogenization treatment, to obtain hot-rolled sheets having a thickness of 5.0 mm. At this time, hot rolling was performed by rough rolling and then finish rolling. In addition, in the hot rolling, the start temperature of the rough rolling (the start temperature of the hot rolling) was set to 350° C. by heating the aluminum-alloy ingot, prior to being fed to the rough rolling, to 350° C. and holding it for 6 hours. In addition, the end temperature of the rough rolling (the intermediate temperature of the hot rolling) was set to 320° C., and the end temperature of the finish rolling (the end temperature of the hot rolling) was set to 180° C. In the present example as such, not only were the start temperature and the end temperature of the hot rolling set to 350° C. or less but also the end temperature of the rough rolling—which is a midstream temperature of the hot rolling, that is, the start temperature of the finish rolling—was set to 350° C. or less.

Subsequently, cold rolling was performed repetitively, without performing midstream annealing, and thereby aluminum-alloy foils having a foil thickness of 12 μm were obtained. It is noted that the total reduction in cold rolling was 100×(5.0 mm sheet thickness of the hot-rolled sheet before cold rolling−0.012 mm foil thickness of the aluminum-alloy foil after the final cold rolling)/(5.0 mm sheet thickness of the hot-rolled sheet before cold rolling)=99.8%.

Next, the resulting aluminum-alloy foils were used as samples, and the average crystal-grain sizes, the crystal-orientation-surface-area percentages, and the tensile strengths and elongations after heat treatment were measured. In addition, to examine the foil-rolling state, the rear surface of each sample was illuminated and the presence or absence of pinholes was also examined based on the presence/absence of light leakage.

The average crystal-grain sizes were calculated as below. First, each foil surface to be measured was adjusted by electrolytic polishing the aluminum-alloy foil, which was cut to a size of 15 mm×80 mm, under the conditions of 10 V for 1 min in an aqueous solution of perchloric acid-ethanol (60 ml of 60 mass % perchloric acid+500 ml of ethanol) at −7° C. It is noted that the foil surface is parallel to the rolling surface. Furthermore, the adjusted surface was analyzed by electron backscatter diffraction (EBSD) using an SEM with the observation magnification set to 500 times, and thereby an orientation-mapping image was obtained. Measurements were performed at five visual fields for each sample. Furthermore, based on the resulting orientation-mapping image, a boundary with an orientation difference of 15° or more was taken as the crystal-grain boundary, the region enclosed by the boundary was taken as one crystal grain, and a circle-equivalent diameter was calculated from the surface area thereof, and thereby the crystal-grain size was calculated. It is noted that the average of the crystal-grain sizes was calculated as a surface-area-weighted average, and the average of the five visual fields was taken as the final average crystal-grain size.

Each ratio of the surface-area percentages of the crystal orientations was calculated as below. Specifically, in the orientation-mapping image obtained by the above-mentioned method, the percentage, with respect to the total surface area, of the surface areas of the crystal grains in which the crystal orientation was in a range within 15° from {112}<111> was calculated as A_{{112}<111>}, the percentage, with respect to the total surface area, of the surface areas of the crystal grains in which the crystal orientation was in a range within 15° from {101}<121> was calculated as A_{{112}<121>}, and then A_{{112}<111>}/A_{{101}<121>} was calculated.

The tensile strength and elongation after heat treatment were measured by the methods below. Specifically, the resulting aluminum-alloy foil was used as a sample; after heat treating it at 220° C.×5 h, tensile strength and elongation were measured. Tensile strength and elongation were measured by extracting a JIS No. 5 test piece from the sample in accordance with JIS Z2241. It is noted that those having a tensile strength after heat treatment of 120 MPa or more were determined to be acceptable, and those less than that were determined to be unacceptable. In addition, those having an elongation of 6% or more were determined to be acceptable, and those less than that were determined to be unacceptable. These results were summarized and are shown in Table 2. It is noted that samples E1-E6 are working examples and samples C1-C5 are comparative examples.

TABLE 2

| | | Aluminum-Alloy Foil Properties | | | | |
|---|---|---|---|---|---|---|
| | | | Ratio of Surface-Area | After Heat Treatment | | |
| | | Average | Percentages of | at 220° C. × 5 h | | |
| | | Crystal- | Crystal Orientations | Tensile | | |
| | | Grain Size | A_{{112}<111>}/A_{{101}<121>} | Strength | Elongation | |
| Sample | Alloy | (μm) | (—) | (MPa) | (%) | Pinholes |
| E1 | A | 2.2 | 6.2 | 138 | 11 | Absent |
| E2 | B | 2.4 | 3.8 | 121 | 13 | Absent |
| E3 | C | 2.0 | 4.2 | 142 | 12 | Absent |
| E4 | D | 2.1 | 5.0 | 156 | 6 | Absent |
| E5 | E | 2.2 | 4.8 | 139 | 10 | Absent |
| E6 | F | 1.9 | 3.1 | 144 | 8 | Absent |
| C1 | G | 2.2 | 3.7 | 141 | 8 | Present |
| C2 | H | 2.4 | 6.4 | 115 | 4 | Absent |
| C3 | I | 1.9 | 4.9 | 142 | 9 | Present |
| C4 | J | 2.2 | 3.3 | 144 | 3 | Absent |
| C5 | K | 2.0 | 5.2 | 186 | 2 | Absent |

As shown in Table 2, because sample C1 used alloy G, in which the Si content was more than 0.6%, coarse Si single-phase particles were formed and pinholes caused thereby were created.

Because sample C2 used alloy H, in which the Fe content was below 1.0%, the tensile strength after heat treatment was below 120 MPa, it was difficult to soften because there were few dispersed Al—Fe-based intermetallic compounds and elongation was unacceptable.

In sample C3, because the Fe content was more than 2.0%, coarse compounds were formed during casting and pinholes were created during foil rolling.

In sample C4, because the Cu content was more than 0.1%, it was difficult for softening to occur during the heat treatment and the elongation after heat treatment was below 6%.

In sample C5, because the Mn content was more than 0.05%, it was difficult for softening to occur during the heat treatment and the elongation after heat treatment was below 6%.

### Working Example 2

The present example principally examined the effects of the temperature conditions during hot rolling, the presence/absence of the homogenization treatment, midstream annealing during cold rolling, and the like.

An aluminum-alloy ingot was prepared by manufacturing an ingot of aluminum alloy A, having the chemical composition shown in Table 1, by a semicontinuous-casting method and then surface milling it.

Using aluminum-alloy ingot A, aluminum-alloy foils having a foil thickness of 12 μm were manufactured according to the manufacturing conditions shown in Table 3. In the resulting aluminum-alloy foils, the same as in the Working Example 1, the average crystal-grain sizes, the crystal-orientation surface-area percentages, the tensile strengths and elongations after heat treatment, and the foil-rolling states (presence/absence of pinpoles) were examined. These results were summarized and are shown in Table 4. It is noted that samples E7-E9 are working examples and samples C6-C9 are comparative examples.

TABLE 3

| | | Hot Rolling | | |
|---|---|---|---|---|
| | | Start | End | |
| | Homogenization | Temp. | Temp. | Midstream |
| Condition | Treatment | (° C.) | (° C.) | Annealing |
| 1 | Not Performed | 250 | 206 | Not Performed |
| 2 | 0 | 300 | 235 | Not Performed |
| 3 | 0 | 350 | 263 | Not Performed |
| 4 | 0 | 400 | 318 | Not Performed |
| 5 | 0 | 500 | 366 | Not Performed |
| 6 | 520° C. × 6 h | 350 | 282 | Not Performed |
| 7 | 0 | 350 | 271 | Annealing at |
| | | | | 380° C. when |
| | | | | thickness was 1 mm |

TABLE 4

| | | Aluminum-Alloy Foil Properties | | | | |
|---|---|---|---|---|---|---|
| | | | Ratio of Surface-Area | After Heat Treatment | | |
| | | Average | Percentages of | at 220° C. × 5 h | | |
| | | Crystal- | Crystal Orientations | Tensile | | |
| | | Grain Size | A_{{112}<111>}/A_{{101}<121>} | Strength | Elongation | |
| Sample | Condition | (μm) | (—) | (MPa) | (%) | Pinholes |
| E7 | 1 | 1.9 | 6.8 | 140 | 13 | Absent |
| E8 | 2 | 2.1 | 6.3 | 141 | 11 | Absent |
| E9 | 3 | 2.2 | 4.3 | 138 | 11 | Absent |
| C6 | 4 | 2.3 | 2.8 | 118 | 13 | Absent |
| C7 | 5 | 2.3 | 2.0 | 110 | 12 | Absent |
| C8 | 6 | 2.8 | 3.9 | 107 | 12 | Absent |
| C9 | 7 | 2.9 | 1.1 | 100 | 13 | Absent |

As shown in Table 4, in samples C6 and C7, the hot-rolling start temperature during hot rolling was more than 350° C. Consequently, processing in which A_{{112}<111>}/A_{{101}<121>} was on the order of more than 3.0 was not performed, the increased fineness of the crystal grains after the heat treatment was insufficient, and strength was unacceptable.

Sample C8 was manufactured by performing a homogenization treatment at a high temperature of 520° C., which is more than 350° C., before the start of hot rolling. Consequently, Al—Fe-based compounds were formed and the amount of Fe solid solutes was reduced; thereby, the solid solution hardening effect decreased and the crystal grains were coarsened; as a result, the strength after heat treatment was unacceptable.

In sample C9, the temperature during hot rolling was 350° C. or less; however, during the course of cold rolling, a midstream annealing was performed at a high temperature of 380° C., which is more than 350° C., when the sheet thickness was 1 mm, and thereby sample C9 was manufactured. As a result of work strain being released by the performance of the midstream annealing, the effect of increasing the fineness of the crystal grains due to the accumulation of strain was weakened, and therefore the strength after heat treatment was decreased. In addition, the precipitation of Al—Fe—Si-based compounds was promoted and the amount of Si and Fe solid solutes decreased, which were also causes of a decrease in strength. As a result of these, the strength after heat treatment was unacceptable.

In contrast, in all samples E7E9, which were prepared based on the prescribed conditions, the tensile strength after heat treatment was 120 MPa or more and the elongation was 6% or more.

Therefore, according to the examples described above, it was confirmed that aluminum-alloy foils having high strength and large elongation were obtained, even after having experienced heat treatment during the electrode manufacturing process and the like.

The above explained the details of the working examples of the present invention, but the present invention is not limited to the above-mentioned working examples, and various modifications can be effected within a range that does not depart from the gist of the present invention.

1. An aluminum-alloy foil, wherein:
the aluminum-alloy foil is composed of an aluminum alloy that contains, in mass %, Fe: 1.0% or more and 2.0% or less, Mn: 0.05% or less, and unavoidable impurities; and
an average crystal-grain size at a foil surface is 2.5 μm or less, and a ratio of the surface-area percentages of the crystal orientations A_{{112}<111>}/A_{{101}<121>} is 3.0 or more;
wherein:
said A_{{112}<111>} is the percentage, with respect to the total surface area, of the surface areas of crystal grains in which the crystal orientation is in a range within 15° from {112}<111> in an orientation-mapping image of the foil surface produced by electron backscatter diffraction, and
said A_{{101}<121>} is the percentage, with respect to the total surface area, of the surface areas of the crystal grains in which the crystal orientation is in a range within 15° from {101}<121> in the orientation-mapping image.

2. The aluminum-alloy foil according to claim 1, wherein:
the aluminum alloy further contains at least one of Si and Cu, and
in mass %, Si is 0.01% or more and 0.6% or less and Cu is 0.01% or more and 0.1% or less.

3. The aluminum-alloy foil according to claim 1, wherein the aluminum-alloy foil is for a current collector.

4. An aluminum-alloy-foil manufacturing method, comprising:
rolling an aluminum-alloy ingot into a foil by hot rolling and then cold rolling, wherein:
the aluminum-alloy ingot contains, in mass %, Fe: 1.0% or more and 2.0% or less, Mn: 0.05% or less, and unavoidable impurities;
a homogenization treatment is not performed before the hot rolling;
the hot rolling is performed at a temperature of 350° C. or less;
the cold rolling is performed without a midstream annealing being performed, and
the foil has a thickness of 20 μm or less after cold rolling.

5. The aluminum-alloy-foil manufacturing method according to claim 4 wherein:
the aluminum alloy further contains at least one of Si and Cu and
in mass %, Si is 0.01% or more and 0.6% or less and Cu is 0.001% or more and 0.1% or less.

6. The aluminum-alloy-foil manufacturing method according to claim 4, wherein the aluminum-alloy foil is for a current collector.

7. The aluminum-alloy-foil manufacturing method according to claim 4, wherein the aluminum alloy further contains 0.01-0.6 mass % Si and 0.001-0.1 mass %.

8. The aluminum-alloy-foil manufacturing method according to claim 7, wherein the aluminum-alloy ingot is held at 350° C. for 12 hours or less prior to hot rolling.

9. The aluminum-alloy-foil manufacturing method according to claim 8, wherein the aluminum-alloy ingot is held at 350° C. for 6 hours prior to hot rolling.

10. The aluminum-alloy-foil manufacturing method according to claim 8, wherein the foil is heat treated at 220° C. for 5 hours after cold rolling.

11. The aluminum-alloy-foil manufacturing method according to claim 10, wherein the aluminum-alloy ingot contains 1.2-1.7 mass % Fe.

12. The aluminum-alloy-foil manufacturing method according to claim 11, wherein the aluminum-alloy ingot contains 0.001-0.01 mass % Mn.

13. The aluminum-alloy-foil manufacturing method according to claim 12, wherein the aluminum-alloy ingot contains 0.1-0.4 mass % Si.

14. The aluminum-alloy-foil manufacturing method according to claim 13, wherein the aluminum-alloy ingot contains 0.005-0.09 mass % Si.

15. The aluminum-alloy foil according to claim 2, wherein the aluminum alloy contains 1.2-1.7 mass % Fe.

16. The aluminum-alloy foil according to claim 15, wherein the aluminum alloy contains 0.001-0.01 mass % Mn.

17. The aluminum-alloy foil according to claim 16, wherein the aluminum alloy contains 0.1-0.4 mass % Si.

18. The aluminum-alloy foil according to claim 17, wherein the aluminum alloy contains 0.005-0.09 mass % Si.
